(19) United States
(12) Patent Application Publication
(10) Pub. No.: US 2015/0151846 A1
(43) Pub. Date: Jun. 4, 2015

(54) AIRCRAFT FUEL TANK INERTING ARRANGEMENT

(71) Applicant: AIRBUS OPERATIONS LIMITED, Bristol (GB)

(72) Inventors: Richard HASKINS, BRISTOL (GB); John Alan JONES, BRISTOL (GB)

(21) Appl. No.: 14/554,862

(22) Filed: Nov. 26, 2014

(30) Foreign Application Priority Data
Nov. 29, 2013 (GB) 1321067.9

(51) Int. Cl. B64D 37/32; B64D 37/34

(52) U.S. Cl. CPC B64D 37/32; B64D 37/34

(57) ABSTRACT

A aircraft fuel tank inerting arrangement is provided for providing oxygen-depleted gas to one or more aircraft fuel tanks, the aircraft fuel tank inerting arrangement comprising a gas inlet, an oxygen remover configured to remove oxygen from an oxygen-containing gas, thereby producing an oxygen-depleted gas, a first flow control valve and at least one gas outlet to deliver oxygen-depleted gas to an aircraft fuel tank, the gas inlet being in gaseous communication with, and upstream of, the oxygen remover, the oxygen remover being in gaseous communication with, and upstream of, the at least one outlet, the first flow control valve being operable to provide a variable rate of flow of oxygen depleted gas to at least one gas outlet. An aircraft comprising such a aircraft fuel tank inerting arrangement is also provided, as is a method of providing oxygen-depleted gas to one or more aircraft fuel tanks

### FIELD OF THE INVENTION

The present invention relates to aircraft fuel tank inerting arrangements, aircraft comprising such aircraft fuel tank inerting arrangements and methods of inerting aircraft fuel tank.

### BACKGROUND TO THE INVENTION

It is known to provide an oxygen-depleted atmosphere to an aircraft fuel tank to reduce the risk of an explosion in the fuel tank. An air separation module removes some oxygen from the air, thereby providing oxygen-depleted air to one or more fuel tanks. The rate of oxygen-depleted air passed into a fuel tank typically depends on the stage of flight. For example, a low flow rate of oxygen-depleted gas may be used at the start of a flight (when a fuel tank may typically be full of fuel) and/or when a fuel tank is depressurising (e.g. on ascent). The flow rate of oxygen-depleted air is typically higher when there is less fuel in a fuel tank and/or a fuel tank is being re-pressurised (e.g. on a descent). A typical arrangement used to control flow of oxygen-depleted gas to a fuel tank uses two “on-off” valves in two parallel conduits to provide two different flow rates (plus zero flow) of oxygen-depleted gas.

Such an arrangement lacks control and more oxygen-depleted air than necessary may be supplied to a fuel tank. This may limit the lifetime of the air separation module. The present invention seeks to ameliorate one or more of the problems mentioned above.

### SUMMARY OF THE INVENTION

In accordance with a first aspect of the present invention there is provided an aircraft fuel tank inerting arrangement for providing oxygen-depleted gas to one or more aircraft fuel tanks, the aircraft fuel tank inerting arrangement comprising

a gas inlet, an oxygen remover configured to remove oxygen from an oxygen-containing gas, thereby producing an oxygen-depleted gas, a first flow control valve and at least one gas outlet to deliver oxygen-depleted gas to an aircraft fuel tank,

the gas inlet being in gaseous communication with, and upstream of, the oxygen remover, the oxygen remover being in gaseous communication with, and upstream of, the at least one outlet, the first flow control valve being operable to provide a variable rate of flow of oxygen depleted gas to at least one gas outlet.

The first flow control valve therefore typically operates as a throttle valve, controlling the amount of oxygen-depleted gas being passed to a fuel tank. This control of the gas flow may help control the amount of gas passed through the oxygen remover, thereby extending its life, reducing costs and reducing the amount of servicing the aircraft needs.

The first flow control valve is not merely an “on-off” valve. The first flow control valve typically provides a multiplicity of different valve states in which the gas flow rate is mutually different (and not zero). The first flow control valve typically has a zero flow rate state, too.

Those skilled in the art will realise that the fuel tank(s) is not a part of the aircraft fuel tank inerting arrangement.

The aircraft fuel tank inerting arrangement may comprise more than one outlet for delivering gas to a fuel tank. The first flow control valve may be operable to control flow to at least one, more than one, and optionally each, of the outlets. For example, the aircraft fuel tank inerting arrangement may comprise a plurality of such outlets, each outlet delivering oxygen-depleted gas to a respective fuel tank. The first flow control valve may be operable to control flow to at least one, more than one, and optionally each, of the plurality of outlets. Two or more outlets may deliver oxygen-depleted gas to one fuel tank. The first flow control valve may be operable to control flow to at least one, more than one, and optionally each, of the outlets.

The aircraft fuel tank inerting arrangement may comprise a second flow control valve operable to provide a variable rate of flow of oxygen depleted gas to at least one gas outlet. Further such flow control valves may be provided. The flow control valves may have the same characteristics as the first flow control valve. For example, the further flow control valves may be of the same general type as the first flow control valve, may be of the same size and may be operable in substantially the same manner.

Optionally, at least one of said flow control valves may be located upstream of the oxygen remover. Alternatively or additionally, at least one of said flow control valves may be located downstream of the oxygen remover. For example, the aircraft fuel tank inerting arrangement may comprise a plurality of such flow control valves, and more than one of such flow control valves may be located downstream of the oxygen remover. The first flow control valve may optionally be located upstream of the oxygen remover, and a second flow control valve may be located downstream of the oxygen depletion module.

The aircraft fuel tank inerting arrangement may optionally comprise first and second inerting branches, the first and second inerting branches providing oxygen-depleted gas to a respective fuel tank via a respective outlet, the first inerting branch being provided with the first flow control valve and the second inerting branch being provided with the second flow control valve.

Each of said flow control valves may be selected from the group consisting of a butterfly valve, a poppet valve comprising multiple outlets, a globe valve and a needle valve.

The aircraft fuel tank inerting arrangement may comprise one or more sensors, at least one of said flow control valves being configured to operate dependent on the output of one or more of said sensors. At least one or said flow control valves may therefore operate in a feedback loop with one or more sensor. Typically, a valve will be operated by an actuator and the operation of the actuator would be dependent on the output of one or more sensors.

Each sensor may be individually selected from the group consisting of a flow rate sensor, a gas pressure sensor, a gas pressure difference sensor, an ozone sensor, an actuator position sensor, a nitrogen sensor and an oxygen sensor.

A sensor may be located proximate to a respective flow rate valve, particularly if the sensor is a flow rate sensor or a pressure sensor. An oxygen or nitrogen sensor may, for example, be located downstream of the oxygen depletion module or located in a fuel tank.

It should be noted that a flow rate valve may be operable dependent on one or more sensor outputs and on flight parameters, such as ascent rate, descent rate and altitude.

The gas admitted to the oxygen remover is typically air having an oxygen content of about 21 vol %. The oxygen depletion module is typically operable to reduce oxygen content to from 0.5 to 15 vol %.

The aircraft fuel tank inerting arrangement optionally comprises an ozone reduction module upstream of the oxygen remover. Oxygen removers may be adversely affected by ozone and it is therefore desirable to reduce the amount of ozone entering the oxygen remover.

The aircraft fuel tank inerting arrangement may optionally comprise a gas cooler located upstream of the oxygen remover. Such coolers are preferable, especially if the gas introduced into the aircraft fuel tank inerting arrangement is at an elevated temperature (gas taken from an engine may be at a pre-cooling temperature of about 350° C. which, if not cooled, would have an adverse effect on an oxygen remover). The gas cooler may be operable to reduce gas temperature by at least 50° C., optionally by at least 100° C., optionally by at least 150° C., optionally by at least 200° C. and optionally by at least 200° C.

The aircraft fuel tank inerting arrangement may comprise a gas cooler bypass. The bypass is typically arranged so that a certain, user-controlled amount of gas bypasses (and is therefore not cooled by) the gas cooler. The gas cooler bypass may optionally be provided with a bypass valve for controlling passage of gas through the bypass. A junction is typically provided for the mixing of gas from the bypass with gas which has been cooled by the gas cooler.

The gas cooler may comprise a heat exchanger.

The gas inlet may optionally be arranged to receive gas from an engine of the aircraft.

The aircraft fuel tank inerting arrangement may comprise one or more check valves. Said check valves are one way valves which typically inhibit movement of gas in an upstream direction. Such check valves may be used to inhibit passage of fuel-carrying gas from a fuel tank into one or more parts of the aircraft fuel tank inerting arrangement. For example, it may not be desirable for fuel-carrying gas to make its way into the gas cooler. At least one check valve may be arranged to inhibit movement of fuel from one fuel tank to another.

The aircraft fuel tank inerting arrangement may comprise a filter, optionally a particulate filter. The filter may optionally be located upstream of the oxygen remover, and may optionally be located downstream of the gas cooler, if the gas cooler is present. The filter may comprise an ULPA (ultra-low penetration air) filter, a D-ULPA filter, a carbon-based filter or a HEPA (high efficiency particulate air) filter.

In accordance with a second aspect of the present invention, there is provided an aircraft comprising an aircraft fuel tank inerting arrangement in accordance with the first aspect of the present invention. The aircraft may comprise one or more fuel tanks, the aircraft fuel tank inerting arrangement being arranged to deliver oxygen-depleted gas to one or more of said fuel tanks. For example, the aircraft fuel tank inerting arrangement may be arranged to deliver oxygen-depleted gas to more than one and optionally each of said fuel tanks. The inlet of the aircraft fuel tank inerting arrangement may be arranged to receive gas from an engine of the aircraft, for example from an engine bleed line.

In accordance with a third aspect of the present invention, there is provided a method of providing oxygen-depleted gas to one or more aircraft fuel tanks, the method comprising:

Providing an inlet gas having a first level of oxygen;

Treating said inlet gas, thereby reducing the amount of oxygen therein to provide an oxygen-depleted gas having a level of oxygen lower than the first level;

Passing said oxygen-depleted gas to the one or more aircraft fuel tanks, the flow of oxygen-depleted gas to the one or more fuel tanks being controlled by a flow control valve operable to provide a variable rate of flow of oxygen-depleted gas.

The method may comprise sensing one or more properties of a gas, and operating the flow control valve dependent on the sensed one or more properties of the gas. For example, the method may comprise sensing a property of the gas (such as the oxygen or nitrogen content of the oxygen-depleted gas), for example, immediately downstream of the flow control valve or in a fuel tank, and operating the flow control valve in response to the sensed property of the gas.

The method may comprise operating the flow control valve in response to one or more flight parameters, such as aircraft attitude, altitude, ascent rate and descent rate.

It will of course be appreciated that features described in relation to one aspect of the present invention may be incorporated into other aspects of the present invention. For example, the method of the third aspect of the invention may incorporate any of the features described with reference to the aircraft fuel tank inerting arrangement of the first aspect of the invention and vice versa. For example, the method of the third aspect of the present invention may use the aircraft fuel tank inerting arrangement of the first aspect of the present invention.

### DESCRIPTION OF THE DRAWINGS

Embodiments of the present invention will now be described by way of example only with reference to the following figures of which:

FIG. 1 is a schematic figure of a first embodiment of the invention; and

FIG. 2 is a schematic figure of an aircraft showing the positions of valves in a second embodiment of the invention.

### DETAILED DESCRIPTION

An embodiment of an aircraft fuel tank inerting arrangement of the present invention will now be described by reference to

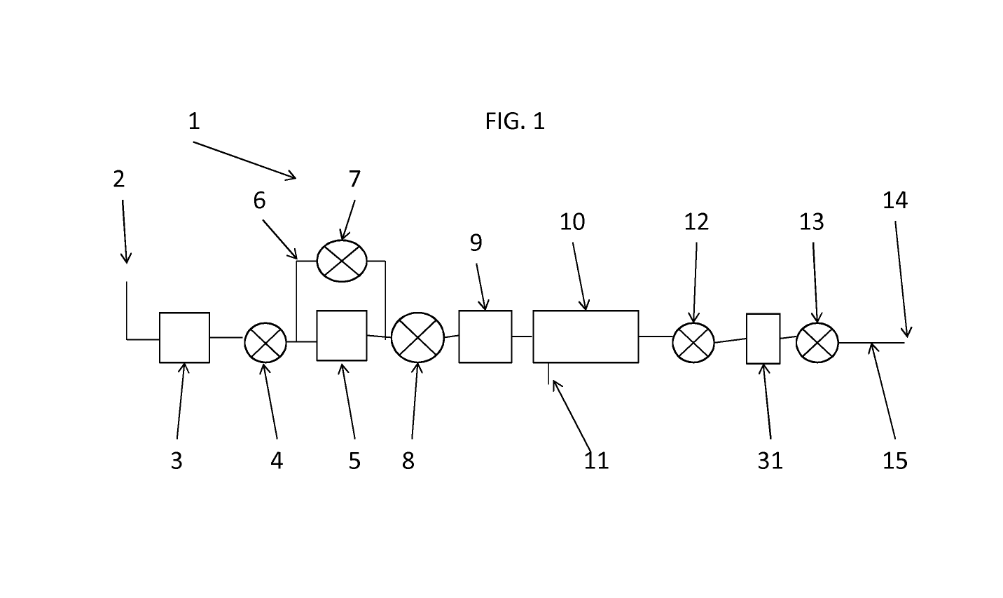

FIG. 1. The aircraft fuel tank inerting arrangement is shown generally by reference numeral 1. The aircraft fuel tank inerting arrangement 1 comprises an inlet 2 arranged to receive air from an aircraft engine bleed line (not shown). The air received from the engine bleed line is typically at a temperature of about 350° C. The air passes downstream through an ozone remover 3 which removes ozone from the air. Ozone can cause problems to other components in the aircraft fuel tank inerting arrangement 1, in particular the air separation module 10 which is discussed in more detail below. Immediately downstream of the ozone remover 3 is a shut-off valve 4 which is closable to prevent gas moving upstream or downstream of the shut-off valve. The shut-off valve 4 is typically used as a safety valve. Downstream of the shut-off valve 4 is a heat exchanger 5 which cools the gas passing there through, typically from 350° C. to between 50° C. and 100° C. A bypass line 6 is provided which allows a certain proportion of uncooled gas to bypass the heat exchanger 5 and to be mixed with gas treated by the heat exchanger 5. A valve 7 is provided in the bypass line 6 to control the amount of gas that passes through the bypass line 6. The bypass line 6 facilitates the control of the temperature of the gas. A further shut-off valve 8 is provided downstream of the junction where the gases from the bypass line 6 and heat exchanger 5 are mixed. The cooled gas is filtered by an ULPA (ultra low particulate air) filter 9 to remove particulate and then passed to an air separation module 10. The air separation module 10 removes at least some of the oxygen from the gas, with oxygen-depleted air being fed via a flow control valve 12 to an outlet 14 for delivering oxygen-depleted air to a central fuel tank (not shown). The air separation module 10 typically comprises a multiplicity of aligned permeable fibres. The lateral walls of the fibres have a greater permeability to oxygen than nitrogen, and therefore oxygen permeates laterally through the fibres more than nitrogen, thereby reducing the amount of oxygen in the gas stream. The air separation module also comprises an outlet 11 for the egress therefrom of oxygen-enriched air. Such air is usually dumped overboard the aircraft.

The flow control valve 12 is a globe valve and is operable to finely control the amount of oxygen-depleted gas flowing to the outlet 14. The globe valve comprises a plug or disk (not shown) which is movable towards and away from a valve seat (not shown), thereby varying the flow of gas through the valve 12. The valve plug or disk is associated with an actuator (not shown) in the form of a piston that may be used to move the stem (not shown) of the globe valve, and thereby move the plug or disk of the valve towards or away from the valve seat, thereby changing the rate of flow of gas.

A one-way valve 13 is provided downstream of the flow control valve 12. The one-way valve 13 inhibits passage of gas upstream. This is advantageous because it inhibits passage of fuel-bearing gas from the fuel tank to upstream components, such as the heat exchanger 5 which can be hot.

The aircraft fuel tank inerting arrangement 1 is further provided with a flow sensor 31 immediately downstream of the flow control valve 12. The flow sensor 31 determines the gas flow rate immediately downstream of the flow control valve 12. The flow rate determined by the flow sensor 31 is compared with a desired value or range of values which may be determined, for example, by the amount of fuel left in the fuel tank and/or on the stage of the flight (e.g. descent, climb or level flight). The difference between the measured value and desired value may be used to control the actuator associated with the flow control valve 12. For example, if the flow rate is too high, the actuator may be used to close the valve, thereby reducing the flow rate. The arrangement of FIG. 1 and the use of such a flow control valve 12 enable the fine control of the amount of gas passing through the air separation module, thereby reducing the frequency with which it has to be replaced.

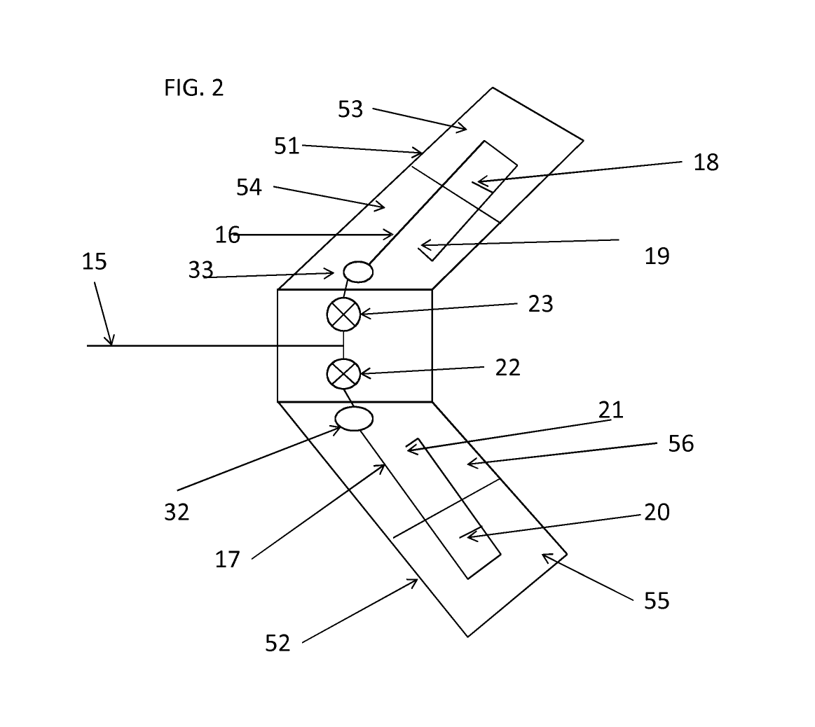

A further embodiment of an aircraft aircraft fuel tank inerting arrangement is shown in FIG. 2. The aircraft fuel tank inerting arrangement is very similar to that shown in FIG. 1, but is used to supply inert gas to fuel tanks located in the wings of an aircraft, instead of a central fuel tank. The fuel inerting system of FIG. 2 comprises conduit 15 provided with oxygen-depleted gas provided by components generally as shown in the arrangement of FIG. 1. The inerting arrangement of FIG. 2 comprises two branches 16, 17 for receiving inert gas from conduit 15 and for delivering oxygen-depleted gas to wing fuel tanks. Each inerting branch 16, 17 extends into a respective wing 51, 52. Each branch 16, 17 is provided with two respective outlets 18, 19, 20, 21 for delivering inerting gas into respective fuel tanks 53, 54, 55, 56. Each branch 16, 17 is provided with a flow control valve 23, 22 for controlling the amount of inert gas delivered to respective fuel tanks. The flow control valves 23, 22 are essentially the same as flow control valve 12 in that they are globe valves. Furthermore, as for flow control valve 12, each flow control valve 23, 22 is associated with an actuator (not shown) for operating the valve. Each of the actuators of flow control valves 23, 22 is operated in response to the output of a respective flow sensor 33, 32, in a similar manner to how flow control valve 12 is operated dependent on the output of flow sensor 31. For example, if the flow rate sensed by flow sensor 33 is too low (for example, if the aircraft is descending and there is a need to provide the fuel tanks 53, 54 with large quantities of inert gas), then valve 23 may be opened to permit a higher flow rate of gas through branch 16.

Whilst the present invention has been described and illustrated with reference to particular embodiments, it will be appreciated by those of ordinary skill in the art that the invention lends itself to many different variations not specifically illustrated herein. By way of example only, certain possible variations will now be described. Those skilled in the art will realise that the flow control valve may be of a different type, such as a butterfly valve or a needle valve. Furthermore, the flow control valve may be located in a different position relative to the other components. For example, the flow control valve may be located upstream of the air separation module, optionally in combination with a flow control valve downstream of the air separation module.

Those skilled in the art will realise that different valve actuators may be used. This may depend to some extent, for example, on the type of valve used.

The examples above describe the use of a flow sensor to control the operation of a respective flow control valve. Other sensors (or combinations of sensors) may be used. For example, an oxygen sensor may be used to sense the oxygen content of gas being fed into the fuel tanks and the flow control valve may be operable in response to the sensed values. Alternatively or additionally, an oxygen sensor may be used to sense the oxygen content of gas in the fuel tank, and the flow control valve may be operable in response to the sensed values.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An aircraft fuel tank inerting arrangement for providing oxygen-depleted gas to one or more aircraft fuel tanks, the aircraft fuel tank inerting arrangement comprising:
A gas inlet, an oxygen remover configured to remove oxygen from an oxygen-containing gas, thereby producing an oxygen-depleted gas, a first flow control valve and at least one gas outlet to deliver oxygen-depleted gas to an aircraft fuel tank,
the gas inlet being in gaseous communication with, and upstream of, the oxygen remover, the oxygen remover being in gaseous communication with, and upstream of, the at least one outlet, the first flow control valve being operable to provide a variable rate of flow of oxygen-depleted gas to at least one gas outlet.

2. The aircraft fuel tank inerting arrangement according to claim 1 comprising more than one outlet for delivering gas to a fuel tank, each outlet being arranged for delivering oxygen-depleted gas to a respective fuel tank.

3. (canceled)

4. The aircraft fuel tank inerting arrangement according to claim 1 comprising two or more outlets arranged to deliver oxygen-depleted gas to one fuel tank.

5. The aircraft fuel tank inerting arrangement according to claim 1 comprising a second flow control valve operable to provide a variable rate of flow of oxygen depleted gas to at least one gas outlet.

6. (canceled)

7. (canceled)

8. The aircraft fuel tank inerting arrangement according to claim 5 comprising first and second inerting branches, the first and second inerting branches provided oxygen-depleted gas to a respective fuel tank via a respective outlet, the first inerting branch being provided with the first flow control valve and the second inerting branch being provided with the second flow control valve.

9. The aircraft fuel tank inerting arrangement according to claim 1 wherein the first flow control valve is selected from the group consisting of a butterfly valve, a globe valve and a needle valve.

10. The aircraft fuel tank inerting arrangement according to claim 1 comprising one or more sensors, at the first flow control valve being configured to operate dependent on the output of one or more of said sensors.

11. (canceled)

12. (canceled)

13. The aircraft fuel tank inerting arrangement according to claim 10 comprising an oxygen or nitrogen sensor located downstream of the oxygen depletion module or located in a fuel tank.

14. The aircraft fuel tank inerting arrangement according to claim 10 wherein the first flow control valve is operable dependent on one or more sensor outputs and on flight parameters.

15. (canceled)

16. The aircraft fuel tank inerting arrangement according to claim 1 comprising a gas cooler located upstream of the oxygen remover.

17. (canceled)

18. The aircraft fuel tank inerting arrangement according to claim 16 comprising a gas cooler bypass.

19. (canceled)

20. (canceled)

21. The aircraft fuel tank inerting arrangement according to claim 16 wherein the gas cooler comprises a heat exchanger.

22. The aircraft fuel tank inerting arrangement according to claim 1 wherein the gas inlet is arranged to receive gas from an engine of the aircraft.

23. (canceled)

24. The aircraft fuel tank inerting arrangement according to claim 1 any preceding claim comprising a filter located upstream of the oxygen remover.

25. (canceled)

26. An aircraft comprising an aircraft fuel tank inerting arrangement and one or more fuel tanks, the fuel tank inerting arrangement comprising:
A gas inlet, an oxygen remover configured to remove oxygen from an oxygen-containing gas, thereby producing an oxygen-depleted gas, a first flow control valve and at least one gas outlet to deliver oxygen-depleted gas to an aircraft fuel tank,
the gas inlet being in gaseous communication with, and upstream of, the oxygen remover, the oxygen remover being in gaseous communication with, and upstream of, the at least one outlet, the first flow control valve being operable to provide a variable rate of flow of oxygen-depleted gas to at least one gas outlet;
the aircraft fuel tank inerting arrangement being arranged to deliver oxygen-depleted gas to one or more of said fuel tanks

27. An aircraft according to claim 26 wherein the inlet of the aircraft fuel tank inerting arrangement is arranged to receive gas from an engine of the aircraft.

28. A method of providing oxygen-depleted gas to one or more aircraft fuel tanks, the method comprising:
Providing an inlet gas having a first level of oxygen;
Treating said inlet gas, thereby reducing the amount of oxygen therein to provide an oxygen-depleted gas having a level of oxygen lower than the first level; and
Passing said oxygen-depleted gas to the one or more aircraft fuel tanks, the flow of oxygen-depleted gas to the one or more fuel tanks being controlled by a flow control valve operable to provide a variable rate of flow of oxygen-depleted gas.

29. The method of claim 28 comprising sensing one or more properties of a gas, and operating the flow control valve dependent on the sensed one or more properties of the gas.

30. The method of claim 29 comprising sensing a property of the gas immediately downstream of the flow control valve or in a fuel tank, and operating the flow control valve in response to the sensed property of the gas.

31. The method of claim 28 comprising operating the flow control valve in response to one or more flight parameters.
